(19) United States
(12) Patent Application Publication
(10) Pub. No.: US 2024/0053705 A1
(43) Pub. Date: Feb. 15, 2024

(54) DIGITAL HOLOGRAM IMAGING DEVICE INCLUDING ACOUSTIC MODULE

(71) Applicants: YILDIZ TEKNIK UNIVERSITESI, Istanbul (TR); DOKUZ EYLUL UNIVERSITESI REKTORLUGU STRATEJI GELISTIRME DAIRE BASKANLIGI, Izmir (TR); MARMARA UNIVERSITESI STRATEJI GELIS. DAI. BSK. MUHASEBE BIRIMI, Istanbul (TR); GEBZE TEKNIK UNIVERSITESI, Kocaeli (TR)

(72) Inventors: Huseyin UVET, Istanbul (TR); Yasemin BASBINAR, Izmir (TR); Gokhan Bora ESMER, Istanbul (TR); Muhammed Enes ORUC, Kocaeli (TR)

(73) Assignees: YILDIZ TEKNIK UNIVERSITESI, Istanbul (TR); DOKUZ EYLUL UNIVERSITESI REKTORLUGU STRATEJI GELISTIRME DAIRE BASKANLIGI, Izmir (TR); MARMARA UNIVERSITESI STRATEJI GELIS. DAI. BSK. MUHASEBE BIRIMI, Istanbul (TR); GEBZE TEKNIK UNIVERSITESI, Kocaeli (TR)

(21) Appl. No.: 18/267,102

(22) PCT Filed: Nov. 29, 2021
(86) PCT No.: PCT/TR2021/051311

§ 371 Date: Jun. 23, 2023

(30) Foreign Application Priority Data
Dec. 14, 2020 (TR) 2020/20477

(51) Int. Cl. G03H 1/08; G03H 1/04

(52) U.S. Cl. CPC G03H 1/0866; G03H 1/0443; G03H 2225/21; G03H 2001/005

(57) ABSTRACT

A Quantitative Phase Imaging system uses acoustic pressure waves and has capability to measure the nano-mechanical disturbances formed on the cell. By means of the obtained images, cell hardness can be measured and the pato-physiologic features of the cancer cells shall be characterized. By means of this method where mechanical interaction is not directly used, it is aimed to display the characteristic vibration rings formed by the acoustic vibration rings on the cancer sample.

### CROSS REFERENCE TO THE RELATED APPLICATIONS

This application is the national phase entry of International Application No. PCT/TR2021/051311, filed on Nov. 29, 2021, which is based upon and claims priority to Turkish Patent Application No. 2020/20477, filed on Dec. 14, 2020, the entire contents of which are incorporated herein by reference.

### TECHNICAL FIELD

The present invention relates to a digital hologram imaging device which is capable of measuring nano-mechanical disturbances, formed on the cell, by using acoustic pressure waves thanks to including additionally acoustic module components.

### BACKGROUND

Cancer can be essentially defined as proliferation of cells, which lose division control, in a non-intermittent manner. As a result of mutation and damage which occur in cell DNA, division speed abnormally increases and specific tissue cells proliferate in a rapid manner. These cells which grow in an uncontrolled manner form tumor tissues by coming together in the form of bulks. The tumors which compress healthy tissue cells and which show growth into healthy tissues or which disrupt the tissue are named as malign, and they generally make metastasis to the other regions of the body by means of lymph or blood circulation. They form new tumor bulks in the tissue cells where they are spread, and tumors continue growing and lead to showing canceration characteristic by other tissue cells.

There are now some deficiencies in detection of unhealthy cells like cancer cells. Particularly it is difficult to distinguish the cancer cells in circulation because they are similar to normal blood components in terms of dimension (15-20 μm on the average) and because they are relatively low in number. The occupation capabilities of cancer cells, as beginning from the basal membrane, are defined as the critical step during metastasis.

The increase in protease secretion which triggers basal membrane disturbance leads to changes in cell frame architecture of cancer cells. This condition can increase the mechanical flexibility structure of the cancer cells up to 70%. The hardness condition of cancer cell is a mechanical change and can be detected by examining mechanical changes in cell outer frame.

Quantitative Phase Imaging, which is a numerical holographic method, can be used with success for examination of transparent structures as in biological samples.

With the help of numerical holographic imaging methods, examination of particles with micro-nano level is possible. In literature, it is seen that this method is used as a non-invasive method (non-destruction methods) in obtaining three-dimensional (3D) morphologic characteristics of cells. Even though this method gives information about morphologic structures and refraction indices of cells, this method is not sufficient in separating the cancer cells, which are in circulation, from other circulation cells.

By means of numerical holography method, speckle noise occurs in the captured refraction patterns because the used light source is phase-compliant although micro-nano level imaging can be realized. If the noise ratios in the refraction patterns are high, the 3D (3-dimensional) structure of the cell may be erroneously calculated. In order to reduce these errors to minimum, pluralities of refraction patterns are captured by means of the rapid camera system and the average thereof is taken, and additionally, the speckle noises and the noises produced by the camera are suppressed by means of direction based filters on each refraction pattern image.

In order to provide imaging of cancer cells, most of the methods, used now, are externally realized by means of mechanical stimulation (AFM probe, micro-pipette aspiration). Although the accuracy of the results obtained by means of methods, which have contact, is better when compared with the contactless methods, their operation speeds are substantially low for detection and observation of cancer cells. Although operation speeds of contactless methods are high, the accuracy proportions must be developed.

The photo-acoustic method, which is a contactless method, is based on the principle of reading of the signals, formed by a cell subjected to thermal expansion at high frequency with femto-second laser, by means of acoustic transducer. In this method, vibrations are formed on the cell depending on impulse intervals of the laser. The effect of vibrations is read by using acoustic transducer, and vibration difference is observed. The vibration difference gives information about the visco-elastic structure of the cell. In the measurements made by using acoustic receiver and transmitter, acoustic pressure waves are sent to the cell at specific frequency intervals. The displacement value formed by these waves is read as in the photo-acoustic method, and the vibration frequency values of healthy and unhealthy cells are measured. The difference in between provides the hardness values of the cell.

As a result, because of the abovementioned problems, an improvement is required in the related technical field.

### SUMMARY

The present invention relates to a digital hologram imaging device, for eliminating the abovementioned disadvantages and for bringing new advantages to the related technical field.

An object of the present invention is to provide a digital hologram imaging device which has mechanical contactless and precise reading capability for cancer cells.

An object of the present invention is to provide a digital hologram imaging device which can realize real-time metastasis diagnose, which is compliant to the dynamic change of the disease, at molecular level.

An object of the present invention is to provide an alternative digital hologram imaging device where pato-physiological changes can be observed by means of measurement of the mechanical hardness values of cancer cells.

In order to realize the abovementioned objects and the objects which are to be deducted from the detailed description below, the present invention relates to a digital hologram imaging device. Accordingly, in said device, together with the laser module and the components thereof which provide realization of the desired measurements, there are acoustic module and the components thereof for providing perfection of the measurements. Thus, a digital hologram imaging device is obtained where mechanical interaction is not directly used and where the characteristic vibration rings can be displayed which are formed on the cancer cell by the acoustic vibration rings and where the quantitative data can be recorded as a result.

In the invention, said digital hologram imaging device has a body, a sample plane where the sample positioned on the body is placed, and objective elements; said digital hologram imaging device is characterized by:
an acoustic module positioned at the top part of the body and which has elements which produce and carry acoustic signals which lead to controlled disturbances in the structure of the sample where measurement shall be realized;
a laser module positioned at the lower part of the body and where the desired rays are obtained and guided;
a digital camera where the obtained refraction patterns are recorded thanks to the interaction formed by the laser module and the acoustic module on the sample;
a measurement module where the recorded refraction patterns are transferred from the digital camera and where quantitative values are obtained. Thanks to the device comprising said components, the change created by the vibration, which is formed by the acoustic pressure waves on the cell outer frame and the surface thereof, on the phase and amplitude values of the phase-compliant light can be examined. Thanks to these obtained data, a diagnosis can be realized about the pato-physiological conditions of the cell.

In a possible embodiment of the present invention, said acoustic module comprises at least one carrier cable positioned at the upper part of the body and which provides reaching of acoustic signals, obtained in the acoustic module, to the sample. Acoustic signals, which have frequency and amplitude which provide controlled disturbance for the sample, must be obtained. The carrier cables provide reaching of these obtained acoustic signals to the sample.

In a possible embodiment of the present invention, the acoustic module comprises at least one acoustic transducer which provides formation of different frequency values for the sample and connected to the carrier cable which provides carrying of acoustic signals.

In a possible embodiment of the present invention, the acoustic transducer comprises at least one mirror positioned in a connected manner at the upper part thereof and which provides reflection of the rays, coming from objectives, to the sample in a manner forming the most suitable refraction pattern of the sample.

In a possible embodiment of the present invention, at least one positioner is provided which provides positioning in micro or nano dimensions at the left lower region of the body and which provides formation of the desired refraction patterns.

In a possible embodiment of the present invention, said positioner is positioned at the upper part of the body.

### BRIEF DESCRIPTION OF THE DRAWINGS

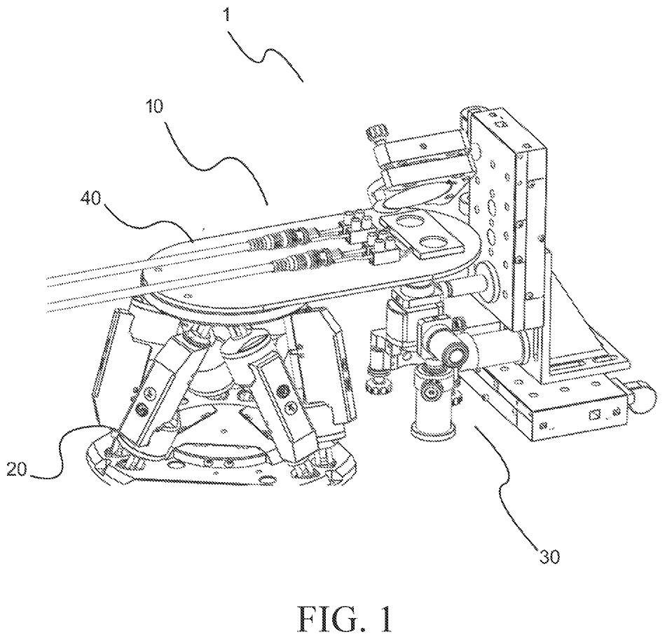

In FIG. 1, an isometric view of the subject matter digital hologram imaging device is given.

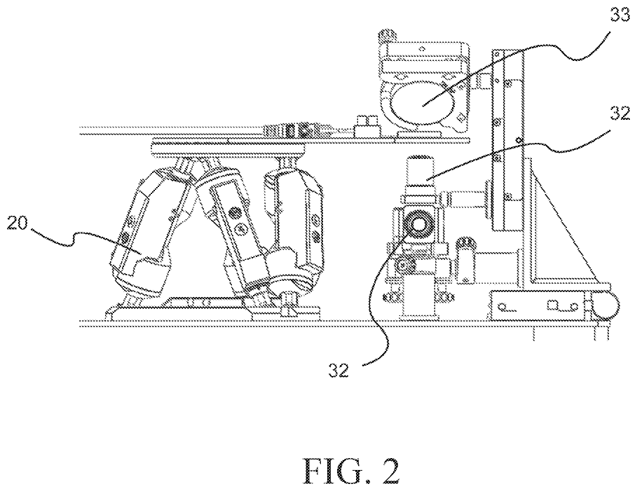

In FIG. 2, the frontal view of the subject matter digital hologram imaging device is given.

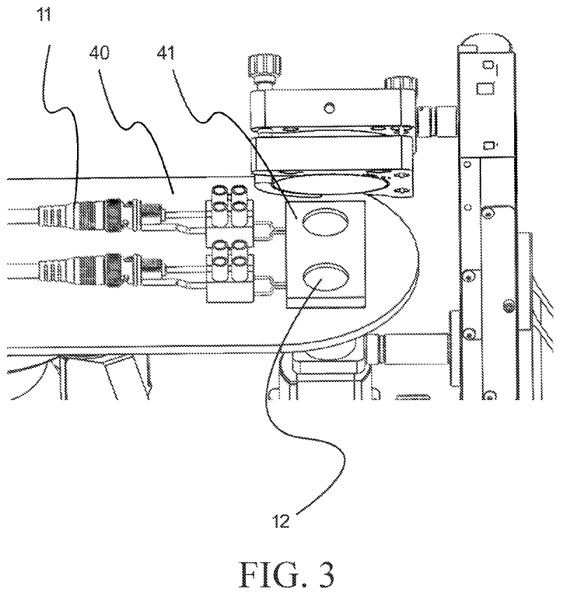

In FIG. 3, the top view where the acoustic module and body elements of the subject matter digital hologram imaging device are shown is given.

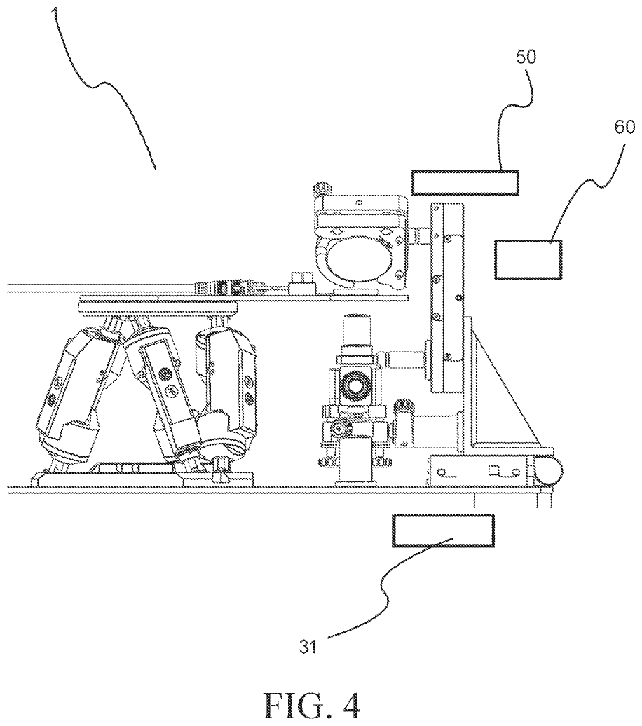

In FIG. 4, the view where the positions of digital camera, measurement module and laser ray source of the subject matter digital hologram imaging device are shown is given.

### REFERENCE NUMBERS

1 Quantitative imaging device
   10 Acoustic module
      11 Carrier cables
      12 Transducer
   20 Positioner
   30 Laser module
      31 Laser ray source
      32 Objective
      33 Mirror
   40 Body
      41 Sample plane
   50 Digital camera
      60 Measurement module

### DETAILED DESCRIPTION OF THE EMBODIMENTS

In this detailed description, the subject matter relates to a digital hologram imaging device (1) which is capable of measuring nano-mechanical disturbances, formed on the sample, by using acoustic pressure waves thanks to including additionally acoustic module (10) components, and is explained with references to examples without forming any restrictive effect only in order to make the subject more understandable.

The present invention is based on forming a “Quantitative Phase Imaging” system which has capability of measuring the nano-mechanical disturbances, forming on the cell, by using acoustic pressure waves. By means of the obtained images, cell hardness shall be able to be measured, and pato-physiological characteristics of the cancer cells shall be characterized. By means of this method where direct mechanical interaction is not used, it is aimed to display characteristic vibration rings formed on the cancer sample by acoustic vibration rings.

The imaging system to be developed is a “non-destructive analysis method” which can make measurement by sending ultrasonic waves at specific frequencies onto the cell. This shall be a “label-free” method which can make measurement by utilizing phase and amplitude shifts in light which shall be formed by the pressure waves on the cell. The device which shall be developed within this scope shall be tried on cancer cells in circulation in the in-vitro conditions. Thus, an approach used in diagnosis and tracing of cancer is developed.

In FIG. 1, the schematic view of the digital hologram imaging device (1) where the subject matter acoustic module (10) is added is given. Said digital hologram imaging device (1) essentially comprises five main structures. Said structures comprise an acoustic module (10) which include the elements which provide operation of the acoustic structure; a laser module (30) including elements which provide realization of the required light refraction; a digital camera system (50) which provides obtaining of the desired images; and quantitative measurement module (60) which provides quantitative illustration of the desired values.

The subject matter digital imaging device (1) comprises a body (40) which provides positioning of modules described beforehand and whereon the sample is placed. Said body (40) has a compartment wherein the sample which shall be measured and named as sample plane (41) is placed.

In FIG. 2, the isometric view of the subject matter digital hologram imaging device (1) is given, here, the view of said body (40) is provided. Accordingly, acoustic module (10) elements, which provide high frequency, are positioned at the upper part of the body (40).

In FIG. 3, another view of the subject matter digital hologram imaging device (1) is given, here, laser module (30) elements, where the desired rays are guided, are positioned at the lower part of the body (40). In case preferred, the laser module elements (30) can be positioned in configurations in a manner affecting the sample also at the other parts of the body (40).

In FIG. 4, the lateral view of the subject matter digital hologram imaging device (1) is given, here, at least one positioner (20) is positioned which provides positioning in micro or nano dimensions at the left lower region of the body (40). In case preferred, the positioner (20) can be positioned in configurations in a manner affecting the sample also at the other parts of the body (40).

The basic function of said laser module (30) is to create a ray source for the sample which is to be displayed. As shown in FIG. 4, the laser module (30) comprises at least one laser ray source (31). The laser ray source (31) inside the device is a light source which is phase-compliant and which has single frequency. The wavelength of the laser ray source (31) is at a value between 400 nm and 700 nm. The powers of the lasers used in the system have been selected as class 3-b. Thanks to preferring such a laser ray source (31), damaging of the tissues which are to be examined can be prevented. Moreover, the laser module (30) used in the system must have a single mode. Thanks to this, better imaging can be obtained.

The laser module (30) comprises at least one objective (32) which provides the desired ray to be taken from the source thereof and to come to the examined sample. Said objective (32) functions in guidance and expansion of the beam emitted by the phase-compliant laser light source (31) in order to be able to illuminate the cell regularly. The phase-compliant light source (31) forms a refraction pattern in the reference wave hologram plane by means of the light emitted by the illuminated object, and thanks to this, both the amplitude and phase information of the sample can be obtained. When reconstruction process is realized from the captured refraction pattern, the object can be embodied again as 3D.

The laser module (30) comprises at least one mirror (33) which can be positioned at different angles and which shall fall the laser light source (31) onto the sample to be monitored. The mirror (33) can be positioned at different angles, and its main function is to provide ray angle which will provide the most suitable refraction patterns for the sample.

The subject matter digital hologram imaging device (1) comprises an acoustic module (10) which has elements which produce and carry acoustic signals which lead to controlled disturbances in the structure of the sample where measurement shall be realized. Acoustic signals, which have frequency and amplitude which provide controlled disturbance for the sample, must be obtained.

Said acoustic module (10) comprises at least one carrier cable (11) which provides reaching of the acoustic signals, obtained in the body, to the sample and positioned at the upper part of the body (40). The carrier cables (11) provide reaching of these obtained acoustic signals to the sample.

The acoustic module (10) comprises at least one acoustic transducer (12) which provides formation of different frequency values for the sample. The acoustic transducer (12) is configured preferably at the upper part of the body (40) and in a manner interacting with the sample in the best manner. The view of the acoustic transducer (12) on the body (40) is given in FIG. 2 and FIG. 3 in details.

The high frequency signals obtained in the acoustic module (10) are transferred to the acoustic transducer (12) by means of carrier cables (11). The transducer (12) converts the received electrical signal into vibration and provides controlled vibration of the cells by means of acoustic signals. The acoustic signal which leads to said vibration is at a frequency value between 1 Mhz and 100 Mhz. A force which affects on the cell depending on these signals is formed, and this leads to deformation on the cell surface. Different deformation amplitudes shall be seen in different cells in accordance with the frequency range where the acoustic signal is applied. Thanks to the flexibility characteristic of the cell membrane, cell membrane functions as an elastic spring which absorbs ultrasonic energy. Thus, correlation can be realized about the cell visco-elastic structure, through the wave patterns which shall occur on the cell outer frame structure with different frequency values.

The refraction patterns, obtained from the sample by means of interaction of the acoustic module (10) and the laser module (30), are recorded in order to be transferred to the measurement module (60) by means of a rapid digital camera (50). By means of this, the appearance of the refraction patterns desired from the sample is obtained. The digital camera (50) is positioned preferably at the left upper part of the body (40) of the digital hologram imaging device (1). The digital camera (50) is embodied to provide recording of the refractions in the sample, and the digital camera (50) can be configured such that the best image shall be best positioned on the body (40).

The digital hologram imaging device (1) comprises a measurement module (60) which provides converting of the refraction patterns, which shall be obtained as the acoustic module (10) and the laser module (30) are interacting with the sample, into quantitative values and which provides showing of the obtained values. Here, the values in said measurement module (60) and the reference values can be compared, and interpretations can be made about the results.

The operation principle of the digital hologram imaging device (1) to be obtained by means of the present invention basically provides displaying of the reactions, given by cancer cells to acoustic impulses, in a three-dimensional manner. The sample prepared for imaging is positioned on the measurement plane provided on the body (40). In order to firmly illuminate the examined sample, the phase-compliant lights, coming from the laser light source (31) of the laser module (30), are guided and widened thanks to the objective (32). Afterwards, the acoustic signals obtained from the acoustic module (10) are transferred to acoustic transducers, and here, the acoustic signals are converted into the desired frequencies. The user starts acoustic signal broadcast at determined frequencies. The produced acoustic signals lead to controlled disturbances in the cell structure. The refraction patterns, which are formed by the cell illuminated with the help of mirrors (33) and objective (32) which are laser module (30) elements, are captured by high-speed camera (50). In order to remove the 3D structure of the cell, refraction pattern with four different phases is needed. Therefore, the position of the objective (32) element can be precisely changed by means of the positioner (20) elements provided in the system. Thanks to this, refraction patterns are formed for different phases, and the digital camera (50) is optically fallen onto the element. The captured refraction patterns of the sample are transferred to the measurement module (60), and thereby the desired values are read.

In the proposed system, pressure is applied to the sample at specific frequencies by means of acoustic waves. The surface changes formed by the acoustic waves on the cell are coded to the refraction patterns formed by the light source. By means of solving of this coding, the changes in the cell can be detected. In this system, the fluctuations on the cell and changes on the cell can be observed in a clearer manner when compared with the above mentioned method, because the wavelength of the phase-compliant light source is much shorter when compared with the wavelength of the acoustic waves. Thanks to this, the changes on the cell can be captured with much higher resolution.

Thanks to the invention, a new method, which is unique for the individual, is proposed for the cancer patients for monitoring the disease by means of a real-time and non-invasive method. Moreover, thanks to this method, there shall be an approach which is a usable method for liquid biopsies and which will increase patient treatment successes.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

What is claimed is:

1. A digital hologram imaging device, comprising:
a body,
a sample plane, wherein a sample positioned on the body is placed on the sample plane,
an objective,
a positioner,
a digital camera, wherein obtained refraction patterns are recorded in the digital camera,
an acoustic module positioned at a top part of the body, wherein the acoustic module has elements configured to produce and carry acoustic signals, wherein the acoustic signals lead to controlled disturbances in a structure of the sample where measurement are realized;
a laser module positioned at a lower part of the body and where rays with specific frequency values are obtained and guided;
a measurement module where the recorded refraction patterns are transferred from the digital camera and where quantitative values are obtained.

2. The digital hologram imaging device according to claim 1, wherein the acoustic module comprises at least one carrier cable positioned at an upper part of the body, wherein the at least one carrier cable provides reaching of the acoustic signals, obtained in the acoustic module, to the sample.

3. The digital hologram imaging device according to claim 1, wherein the acoustic module comprises at least one acoustic transducer, wherein the at least one acoustic transducer provides formation of different frequency values for the sample and is connected to the carrier cable configured to provide carrying of signals.

4. The digital hologram imaging device according to claim 1, wherein at least one mirror is positioned in an associated manner at an upper part of an acoustic transducer and provides reflection of the rays, coming from the objectives, to the sample in a manner forming most suitable refraction patterns of the sample.

5. The digital hologram imaging device according to claim 1, wherein the positioner provides viewing of micro or nano-dimensioned structures positioned at a left lower region of the body and provides formation of the desired refraction patterns.

6. The digital hologram imaging device according to claim 5, wherein the positioner is positioned at an upper part of the body.

7. The digital hologram imaging device according to claim 1, wherein the laser module comprises at least one phase-compliant laser light source, wherein the at least one phase-compliant laser light source provides regular illumination of a cell for the sample.

8. The digital hologram imaging device according to claim 1, wherein the laser light source comprises at least one mirror, wherein the at least one mirror is configured to be fallen on the sample to be monitored and configured to be positioned at different angles.
